(19) United States
(12) Patent Application Publication
(10) Pub. No.: US 2017/0218919 A1
(43) Pub. Date: Aug. 3, 2017

(54) WIND TRACING, ROTATIONAL, SEMI-SUBMERGED RAFT FOR WIND POWER GENERATION AND A CONSTRUCTION METHOD THEREOF

(71) Applicant: Carlos Wong, Macao (CN)

(72) Inventor: Carlos Wong, Macao (CN)

(21) Appl. No.: 15/324,339

(22) PCT Filed: Dec. 23, 2014
(86) PCT No.: PCT/CN2014/094666

§ 371 Date: Jan. 6, 2017

(30) Foreign Application Priority Data
Jul. 8, 2014 (CN) 201410323537.1

(51) Int. Cl. F03D 7/02; F03D 13/25; B63B 1/10; B63B 21/26; B63B 1/12; B63B 21/20; F03D 9/25; B63B 35/44

(52) U.S. Cl. CPC F03D 7/0204; F03D 9/25; F03D 13/25; B63B 35/44; B63B 21/26; B63B 1/125; B63B 21/20; B63B 1/107; F05B 2240/95; F05B 2240/97; F05B 2270/20; B63B 2035/446; B63B 2021/203

(57) ABSTRACT

Disclosed are a semi-submersible raft wind power generation unit and a construction method therefor. The raft wind power generation unit includes at least three floaters (12) and at least three wind turbines (21) configured to be placed on the floaters (12). The raft is configured to turn about a vertical axis and be fixed to a seabed (2) by a mooring line (36). A force resultant from an incoming wind load passes closely around the center of geometry of the raft, which is a distance away from the center of rotation of the raft so that a yaw moment about the center of rotation is created that rotates the raft until the force resultant passes through the center of geometry and center of rotation

### BACKGROUND

Field.

The example embodiments in general are directed to a wind tracing rotational semi-submerged raft for wind power generation deposited in a body of water supporting a plurality of wind turbines facing into wind to generate electricity and its application in offshore wind farms, and to a fabrication and construction method thereof.

Related Art.

Wind energy is an unlimited green energy resource which receives great attention. Offshore wind power generation is more attractive than its land-based counterpart due to its beneficial stronger and static winds.

Because of the nuisances imposed on the adjacent community by near-shore wind farms, and also because a suitable near-shore location is difficult to find, offshore wind farms are moving from near-shore to far-shore locations. In the large open space of the far-shore, the wind is strong and stable, and since the turbines are essentially invisible on shore, opposition from the surrounding community is minimal. Offshore wind farms can be classified as fixed, bottom-type and floating-type wind farms. The former fixes the foundation of the wind turbine to the seabed. The floating-type wind farm is a natural choice for offshore deep water wind farms, since a fixed foundation in a deep water zone is not feasible and the construction risk is substantially high.

Today, most floating turbine supports are designed for single turbine. A major problem faced by the single-turbine floating support is how to limit and stabilize roll and pitch angles to within allowable limits (usually less than 10°). This is extremely difficult to achieve for a single-turbine support because of its small footprint as compared to its tower height. For a single-turbine support system, the turbine tower height is at least twice as much as the support base. Such a construction usually relies on auxiliary mechanisms in order to stabilize the floating turbine. This includes the following conventional methods:
(1) Tension leg. In this method, the floating platform is tied down by cable lines to the seabed anchor in order to resist the uplifting forces induced by floatation of the platform, such that the overturning moment is absorbed into a variation in the tension of the cable lines. An example tension leg system is embodied by the Blue H Group Technologies, Ltd. (“Blue H”) floating platform developed in the United Kingdom;
(2) Adjustable water-ballasting floater system. In this process, the water ballast between floaters of a floating platform is adjusted to balance the overturning moment. An example water-ballasting floater system is embodied by the WindFloat® floating platform manufactured by Principle Power Inc. out of Seattle, Wash.; and the
(3) HyWind Spar platform. Marketed by HYWIND™, this floating offshore spar buoy wind turbine system based on the OC3 Hywind concept is designed to have its center of gravity located below the float center by using a steel rod extended from the bottom of the platform to the deep sea with a heavy mass attached to the end of the rod so as to lower the combined center of gravity below the float center. The steel rod of the HyWind spar buoy is over 100 m; therefore it is only suited for deep water environment.

Apart from the above, Mitsubishi Heavy Industries is currently testing a floating platform known as the Fukushima Mitai that supports a single turbine.

The above-noted conventional wind farms are formed by a plurality of single floating turbines dispersed in a vast stretch of ocean. If the wind field has a dominant wind direction, the wind turbine spacing in the perpendicular direction of the wind can be taken as 1.8D to 3.0D, whereas the turbine spacing in the direction along the wind has to increase to 6.0D to 10D, where D is the diameter of the rotor blades of the turbine. This great separation is adapted to avoid the wake shadow that the upwind turbines cast on the downwind turbines. The wake shadow effects cause a potential power loss in the downwind turbines, and also present a fatigue load on the downwind turbines.

If the wind field has no dominant wind direction, there will be at least one direction that the wind-produced wake shadow casts on the downwind turbines. If the spacing between turbines is maintained too short, the losses from the wake effect will be substantial. Therefore, the spacing is maintained at a minimum of 6.0D. For a modern, large scale turbine, the rotor diameter is over 50 m. In this case, the spacing distance will be 300 m to 500 m. As such, the underwater cable linking the turbines is a great length; the resistance of this substantially long cable will cause a loss in the power transmission.

The wind at sea usually has no dominant direction. In order to catch the maximum wind energy, the turbine rotor should be perpendicular to the wind direction. The concept of placing several turbines on a rotational platform has evolved.

In an example, the WINDSEA™ concept developed by WINDSEA AS of Norway consists of a floating device supporting three (3) wind turbines. The configuration of the floater is of a semi-submersible vessel type with three (3) corner columns, each column supporting one wind turbine thereon. This configuration essentially places three turbines on a triangular platform with a turning axis located in the geometric center. In this configuration, the platform may easily be overturned since there is no self-restoring moment; this is because the turning center is also the geometric center.

EP 1366290 B1, entitled “OFFSHORE FLOATING WIND POWER GENERATION PLANT” by applicant Ishikawajima-Harima Jukogyo Kabushiki Kaisha describes a floating wind power generation plant that turns around a turret that is connected to the platform with a rigid arm while multiple mooring lines are fixed to the turret. This platform cannot be pre-sunk to set up tension in the mooring lines, hence it is easily disturbed by waves. This rigid arm will transfer the dynamic load on the platform to the turret, thereby creating a fatigue problem.

HEXICON™ AB of Stockholm, Sweden is currently testing a multi-turbine floating structure with the turret located at the center of gravity and the turn is by electric power.

### SUMMARY

An example embodiment of the present invention is directed to a semi-submergible raft wind power generation unit. The raft wind power generation unit includes at least three floaters and at least three wind turbines configured for placement on the floaters. The raft is adapted to turn about a vertical axis and be fixed to a seabed by a mooring line. Additionally, a force resultant from a wind load on the raft passes closely around the center of geometry thereof, which is a distance away from the center of rotation thereof so that a yaw moment about the center of rotation is created which rotates the raft until the force resultant passes through the center of geometry and center of rotation.

Another example embodiment is directed to a construction method for fabrication of a semi-submergible raft wind power generation unit. In the method, a plurality of beam segments that make up at least three floaters and their associated connection beams are match casted. Ends of the beam segments are sealed and then transported to an assembly site at a harbor by land or by sea. At least three piles per floater are sunk at a location where a floater is to be positioned at the assembly site, the at least three piles serving as guiding piles to confine the location of the floater. A first bottom floater segment is then temporarily fixed inside a space bounded by the guiding piles, and the floater and connection beam segments are assembled either on land or in the water. The assembled beams are brought to a joint position of the floaters and the assembled beams are temporarily fixed to the guiding piles. Then, a steel mold is set up and a gap between the steel mold and the floater and beam surfaces is sealed. Water is then pumped out of the steel mold, reinforcement is fixed in the joint at the floaters, and concrete is cast in the mold, the wet concrete thereafter cured. Once the concrete has reached its design strength, the floater and connection beams that have been temporarily fixed at the guiding piles are freed. A next floater segment is then loaded onto the first bottom segment and connected thereto with an epoxy coated joint together with pre-stressed steel bars. The loading and connecting steps are repeated until the last floater segment has been connected, and then a wind turbine is installed on the floater. A cable is attached to the bottom end of each floater, with the free ends of the cables brought to a meeting point. The meeting point is at the center of a socket joint for the connection of the cables and a mooring line to the floater bottom and to a seabed anchor. The location of the meeting point does not coincide with the center of gravity of the formed raft unit, but rather is offset from the center of gravity at a distance into the windward side of the raft unit.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limitative of the example embodiments herein.

FIGS. 1A and 1B illustrate traditional 6×6 and 3×4 layouts of wind farms in accordance with an example embodiment.

FIG. 2 is a plan view of a triangular semi-submerged raft wind power generation unit in accordance with an example embodiment.

FIG. 3 is a sectional view 1-1 of FIG. 2.

FIG. 4 is a sectional view 2-2 of FIG. 2.

FIG. 5 is a diagram illustrating how the triangular semi-submerged raft wind power generation unit rotates into a facing wind upon a sudden change of wind direction.

FIG. 6 is a plan view of a star-shaped semi-submerged raft wind power generation unit according to another example embodiment.

FIG. 7 is a sectional view 1-1 of FIG. 6.

FIG. 8 is a sectional view 2-2 of FIG. 6.

FIG. 9 is a diagram illustrating how the star-shaped semi-submerged raft wind power generation unit rotates upon a sudden change of wind direction.

FIG. 10 is a plan view of a T-shaped semi-submerged raft wind power generation unit according to another example embodiment.

FIG. 11 is a sectional view 1-1 of FIG. 10.

FIG. 12 is a sectional view 2-2 of FIG. 10.

FIG. 13 is a plan view of the wind tracing rotational semi-submerged raft wind power generation unit in a trapezoidal layout.

FIG. 14 is a sectional view 1-1 of FIG. 13.

FIG. 15 is a sectional view 2-2 of FIG. 13.

FIGS. 16A and 16B illustrate how the semi-submerged raft wind power generation unit rotates to align in the wind direction after a sudden change of wind direction.

FIG. 17 is an elevation view to illustrate an optional conic body being added to the bottom of the floater for landing on the seabed.

FIG. 18 is a diagram illustrating how the triangular semi-submerged raft wind power generation unit rotates 360° to loosen a twisted power cable.

FIG. 19 is a diagram illustrating fabrication steps (A) through (D) in the assembly and construction of the wind tracing, rotational, semi-submerged raft wind power generation unit in accordance with the example embodiments.

FIG. 20 is a front view to illustrate how the semi-submerged raft wind power generation unit sinks into the water and drops ship's anchor onto the seabed in order to stabilize the raft against storm attack.

### DETAILED DESCRIPTION

As used herein, the term “floater” refers to a floating structure in a body of water on which a wind power turbine may be mounted thereon.

The example embodiments to be more fully described hereafter are directed to a wind tracing, rotational semi-submerged raft wind power generation unit. The semi-submerged raft wind power generation unit or “raft” includes a plurality of at least three hollow, closed cylindrical columns known as floaters which are deposited in and float in a body of water. These floaters are interconnected by a plurality of underwater beams to form an underwater plane frame with the floater situated in the node of the plane frame, thus forming a semi-submerged raft supporting one or more wind turbines on the selected floaters.

The small water plane area of the raft with most of the floatation coming from the raft under the water greatly improves the stability of the raft, hence it is very stable. The raft may be safely anchored to a seabed by a single mooring line that enables the raft to turn along with the wind, so that the wind turbines on the raft are full time wind facing without casting their wake shadow on leeward turbines. The adjacent turbines may be placed in a closer manner, say 1.8D to 2.2D where D is the diameter of the rotor.

By grouping at least three turbines in a raft, an underwater marine power cable carrying the electricity generated by the turbines can be shortened up to 50%. Moreover, with this innovative but mature construction technology, the example semi-submerged rafts are very competitive in deep water zones for wind power generation development. By using pre-stressed concrete, the raft design life may exceed 100 years, as compared with a steel platform which is designed for only 25-30 years. Accordingly, the lifetime costs of the present example embodiments are even less expansive and drastically lower than that attributed to the steel platform. This will enable floating wind farms in far shore deep sea applications to be realized much earlier than expected.

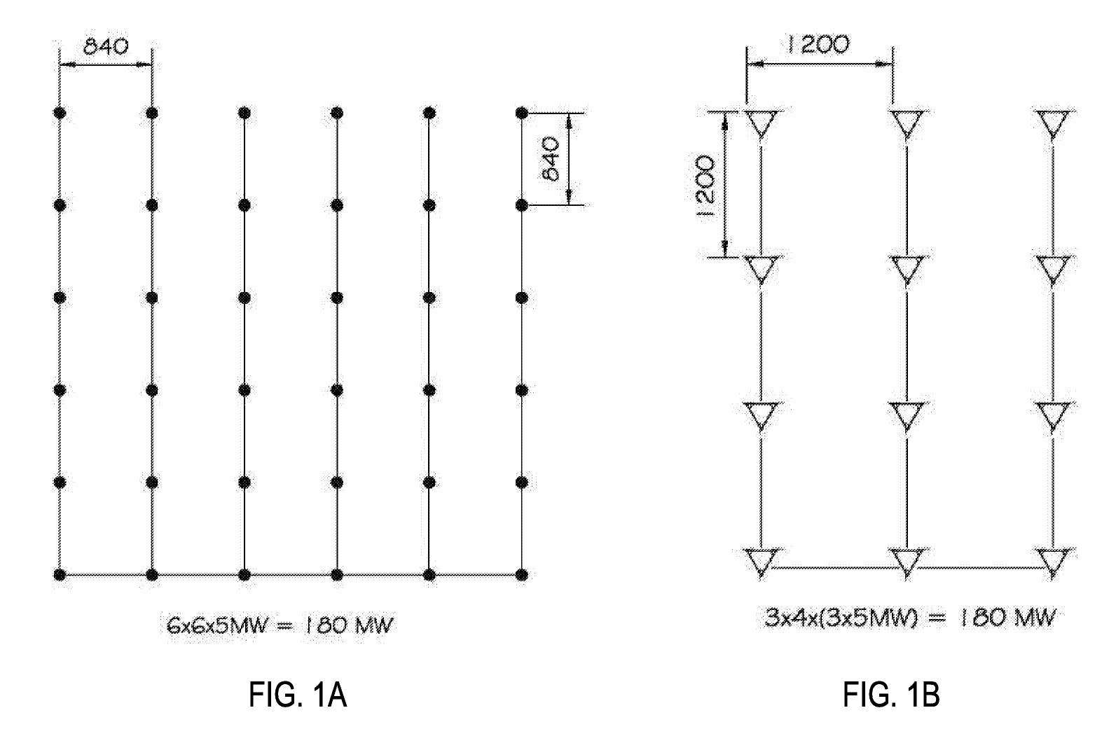

FIGS. 1A and 1B illustrate traditional 6×6 and 3×4 layouts of wind farms in accordance with an example embodiment. FIG. 1A shows a wind farm of 36, 5 MW wind turbines supported by 36 floating platforms in the traditional manner. The total installation capacity is 6×6×5 MW or 180 MW. The distance between adjacent wind turbines is taken as 7.0D where D is the diameter of the rotor and in this case is 120 m, so the distance is 840m and the total marine cable length in the least complex form is 6×(5×840)+5×840 or 29.4 km.

FIG. 1B shows the same turbines supported by the semi-submerged raft wind power generation units in accordance with the example embodiments; a total of 12 units are required. Installation capacity is 12×3×5 or 180 MW. The distance between adjacent turbines is taken as 10D=1260 m. The marine cable needed in the least complex form is 3×(3×1200)+s×1200 or 13.2 km. It is clear that for the same installation capacity, the amount of marine cable needed for the example embodiment layout can be reduced by up to 50%. The 3×4 layout also lowers the transmission loss as the cable length is greatly reduced.

Hereafter, the basic configurations of the example wind tracing rotational semi-submerged raft wind power generation units are described in four different types, namely a triangle, star and a tee(T) configuration as one group for three (3) wind turbines, and a trapezoidal configuration of five (5) wind turbines. It should be understood that any person skilled in the art may derive configurations other than these four basic types, and should be aware that the application of the present example embodiments is not limited to those outlined herein.

Parts List

1. Sea surface 2. seabed/seafloor

3. Ditch

6. Conic object/Conic body

10. Wind tracing rotational semi-submerged raft wind power generation unit

12. Floater

13. Connection beam

14. Vertical diagonal strut

15. Horizontal diagonal strut

16. Raking pile

17. Working platform

21. Wind turbine

22. Tension cable

31. Cable line

32. Cable line

35. Socket joint

36. Mooring line

37. Seabed gravity anchor

39. Rotational axis

40. Cable meeting point

41. Cable line

42. Cable line

48. Guiding pile

49. Steel formwork

50. Center of Geometry

51. Insitu concrete

52. Rudder

53. Working rope for ship's anchor

54. Ship's anchor

60. Power output cable

61. Concrete/stone

62. Sand/gravel

70. Rigid arm

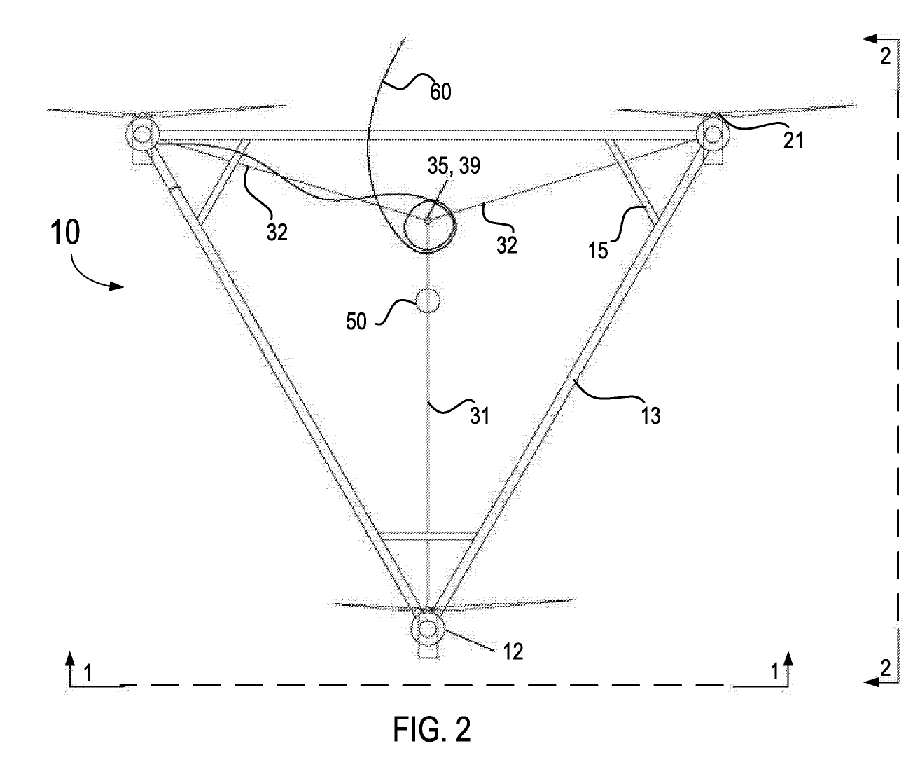

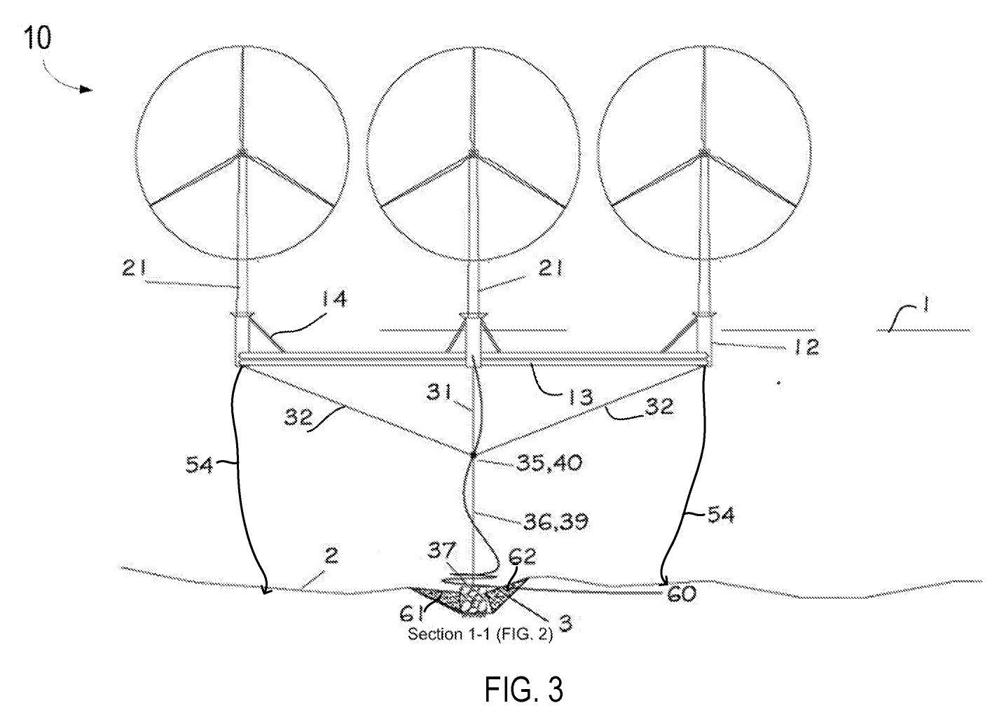

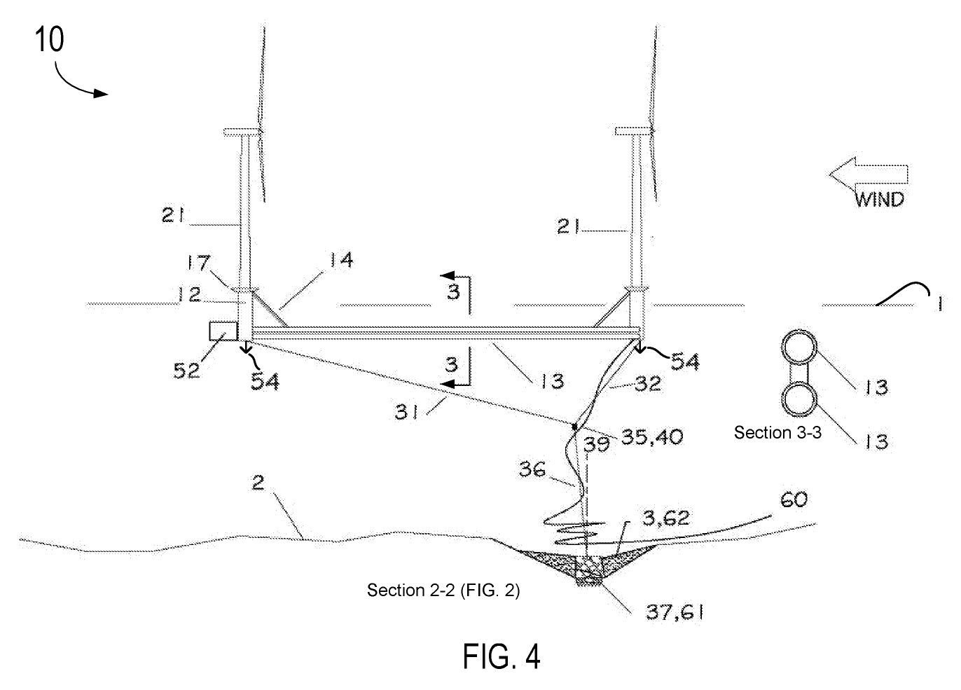

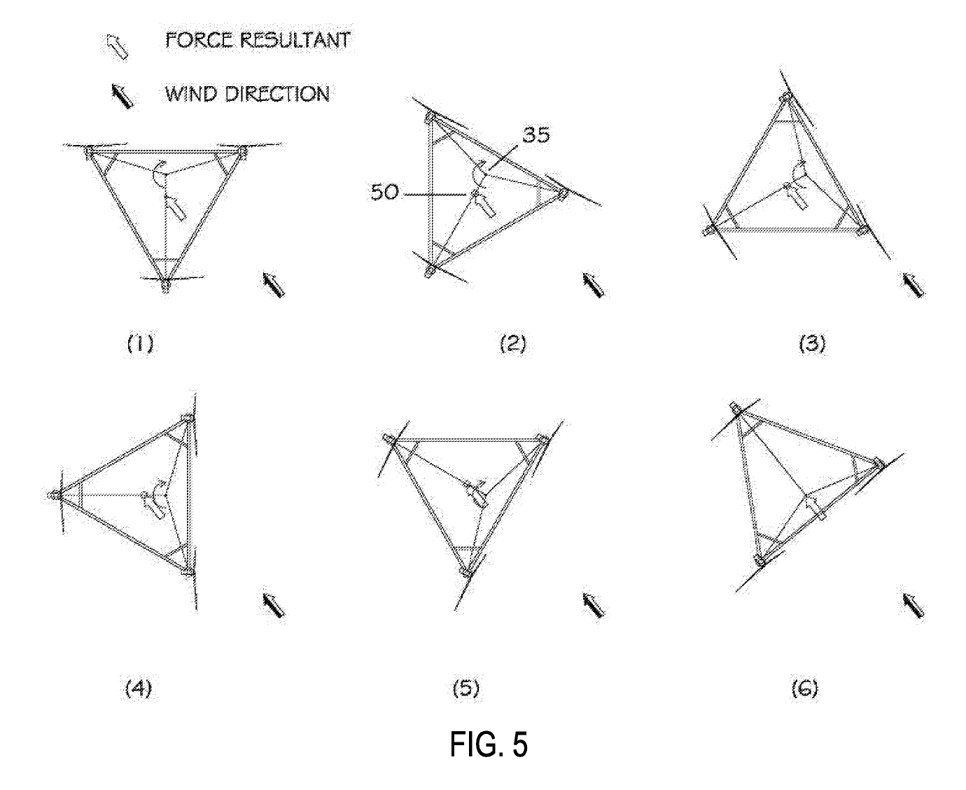

FIG. 2 is a plan view of a triangular semi-submerged raft wind power generation unit in accordance with an example embodiment; FIG. 3 is a sectional view 1-1 of FIG. 2; FIG. 4 is a sectional view 2-2 of FIG. 2; and FIG. 5 is a diagram illustrating how the triangular semi-submerged raft wind power generation unit rotates into a facing wind upon a sudden change of wind direction. Referring to FIGS. 2 through 5, there is shown a triangular configuration of a wind tracing rotational semi-submerged raft wind power generation unit 10 (hereafter “raft 10”) which includes, at each vertex of the triangle, a floater 12 that is connected by underwater connection beams 13 below the water surface 1. In an example, the connection beam 13 may be in a depth of 14m or more below the water surface 1. In this way, a wave has almost no effect on the connection beams 13. The floater 12 and the connection beams 13 form a semi-submerged raft.

The tower of the wind turbine 21 is erected from a working platform 17 in each floater 12; the nacelles of the wind turbines 21 are then installed on the tower. In an operational state, two wind turbines 21 are in a front row to face the wind, leaving the third wind turbine 21 in the aft or leeward side. In one example, the triangle may be an equilateral triangle with the sides proportioned so that the wake shadow of the front turbine 21 does not cast on the third turbine 21 behind it. The wake shadow is thus dispersed at a gentle slope. According to this slope, separation between the turbines 21 can be determined. Apart from this, diagonal struts 14 and 15 are used at the corners between the floater 12 and the connection beams 13, to strengthen the corner.

The size of the connection beams 13 is dependent on the requirement of the stiffness of the connection beams 13 that are needed to limit the rotation of the floater 12 (i.e. the rotation of the wind turbine 21 tower). The rotation of the tower should not be greater than 10°. According to a USA NREL Laboratory report on a simulation analysis of a 5MW offshore wind turbine, the overturning moment at the base is about 250,000 kNM(25000 t-m). If the side of the triangle is 260 m long (i.e. 2.2 times the rotor blade diameter), the variation of the buoyancy in the floater 12 is estimated as 3×25000/260=288 t.

If the floater 12 is taken as having a 10m diameter, the floater 12 needs to move 3.7 m to generate 288 t in order to balance the wind load. The rigid body rotation is only 0.8°, the elastic rotation is 2°, and hence the combined rotation is 3°. If the two opposite floaters 12 move ±4 m by the wave, rotation thus calculated is 3° per floater 12, or a total is 6° which is still within the limit of 10° maximum. It can be seen that the raft 10 is very stable.

As shown in FIG. 2, cables 31, 32 are attached to the floater 12 bottom at one end and to a meeting point at the center of a socket joint 35 at the other end. The cables 31, 32 run at a slope to the meeting point 35, which is at an offset distance from the C.G. 50 (center of geometry or in this case it is also the center of gravity) of the triangle along the bisector of the triangle between the C.G. 50 and the bisector side. The socket joint 35 is connected to a vertically fixed mooring line 36 which is connected to a seabed gravity anchor 37 so that socket joint 35 allows the raft 10 to turn by twisting the mooring line 36. Cables 31, 32 and mooring line 36 are in equilibrium. The turning or rotational axis is denoted by element 39.

Two methods for fixing the triangular semi-submerged raft 10 are used for different purposes. In an operational state a one point anchorage may be used. This may be a one-cable tension leg or just a cable without tension. The tension in the mooring line 36 and the cables 31, 32 are achieved by sinking the raft 10 to a pre-determined depth, tightening the mooring line 36 to the seabed anchor 37, and finally raising the raft 10 by pumping out the water ballast. The raft 10 is restrained by the length of the mooring line 36, thus setting up tension forces in the mooring line 36 and cables 31, 32. Horizontal loads on the turbines 21 cause the raft 10 to move sideways, whereby a reaction is induced in the mooring line 36 and the inclined tensioned mooring line 36 will have a horizontal component to counter balance the external horizontal loads. The overturning moment from the horizontal load is balanced by a pair of buoyancy forces generated by the up and down vertical displacements of the floaters 12.

During an attack of a typhoon, multiple anchor points are used to stabilize the raft 10. As best shown in FIG. 3 as an example, this may be achieved by dropping the ship's anchors 54 stored in each floater 12 to the seabed 2 to stabilize the raft 10. After passing of the storm, these ship's anchors 54 are raised and stored in the floater 12. The raft 10 returns to a normal operation state.

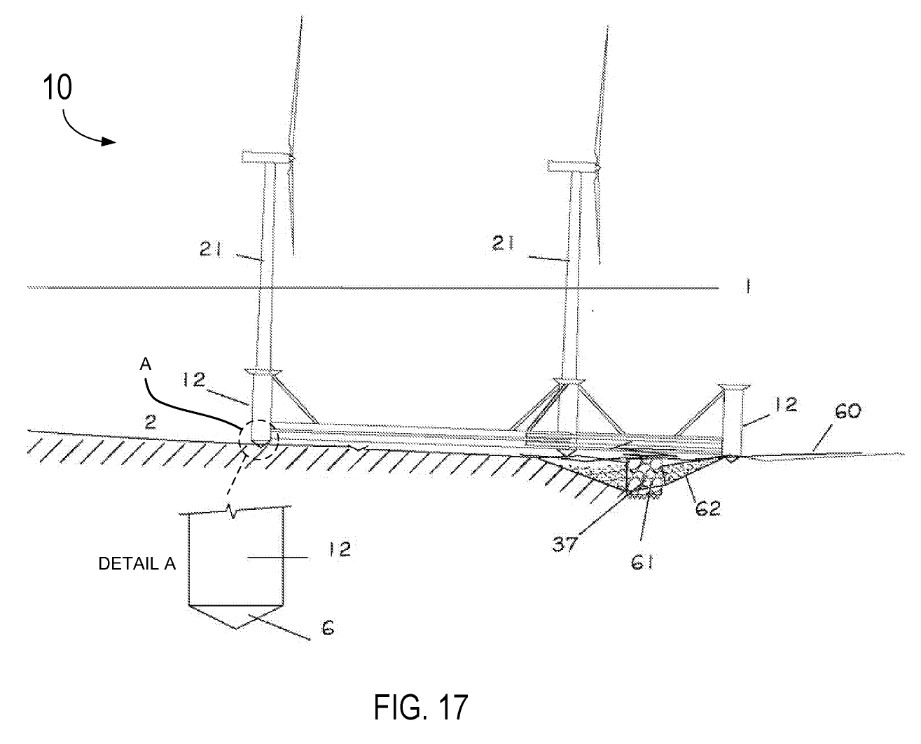

Optionally, to sink the raft 10 to the seabed 2 so that an extraordinary big wave cannot harm the connection beams 13, the bottom of the floater 12 is attached to a landing gear (not shown). Since the self weight of the raft 10 is balanced by the floatation, the sitting force is small and controllable, the landing gear is taken as a downward pointing conic object 6 such that it can penetrate into the seabed 2 to increase its resistance to horizontal forces (refer to FIG. 17).

Further, cables 31, 32 and mooring line 36 are socketed into the socket joint 35. The socket joint 35 is located away from the center of geometry 50 and closer to the bisector side.

FIG. 5 internal diagrams (1) to (6) are provided in order to help explain the mechanism of the wind tracing rotational semi-submerged raft 10. The raft 10 starts at time zero facing north into the incoming wind. In this example the wind suddenly changes to southeast. FIG. 5(1) shows that the S-E wind has its wind force resultant vector acting on the C.G. 50, so it induces a clockwise yaw moment about the vertical turning axis 39 located at the center of socket joint 35. If the aerodynamic forces generated by individual wind turbines 21 are identical in a uniform wind field, the resultant force will pass through the center of geometry 50 which in this case coincides with the center of gravity of the raft 10. If the wind is not uniform, the aerodynamic force resultant fluctuates around the C.G. 50, however, it is unlikely to cross over the socket joint 35 as the turbulence in the wind will be so large that this case is unlikely to occur in a normal operational wind condition.

Although FIG. 5 internal diagrams (2)-(6) demonstrate the principle of wind tracing by assuming the wind force resultant vector acting at the C.G. 50 in a perfectly uniform wind condition, fluctuations in the wind cause the wind force resultant to fluctuate around the C.G. 50, yet still produces a clockwise yaw moment about the vertical rotational axis 39 located in the center of socket joint 35. This turning mechanism is also true if the wind flow is replaced by an ocean underwater incoming current, as the center of geometry 50 in both cases are identical. If the current is significant, the rotor of the turbine 21 is either oriented at an angle to the wind in order to generate a force to counter-balance the underwater current force, or to completely eliminate the effects of the underwater current on raft 10.

The latter is achieved by installing a rudder 52 in the leeward floater 12 (see FIG. 4) and navigating the rudder 52 in order to balance the current force, thus eliminating the current effects on raft 10. The size of the rudder 52 is determined by the current strength. The rudder 52 has another function as it could offer a damping effect to the fluctuating wind force that may cause the raft 10 to yaw and oscillate.

From the above, it can be seen that the example wind tracing rotational semi-submerged raft 10 does not require external power to turn the turbine 21 into the wind. The turbine 21 is turned by nature, i.e., by the wind. This configuration is thus economical and simple in its maintenance requirements.

Referring to FIGS. 2 to 4, the eccentricity of the socket joint 35 away from the center of geometry 50 may be adjusted. Basically, it is adjusted by the length of cables 31 and 32. The larger the distance, the greater the yaw moment induced

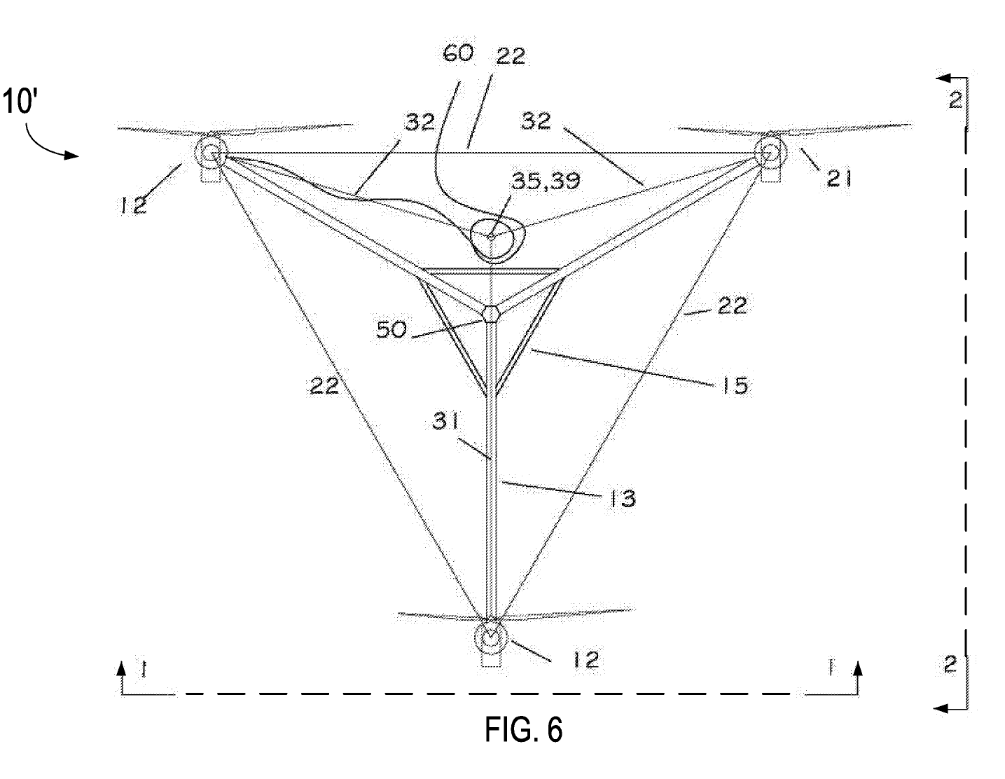

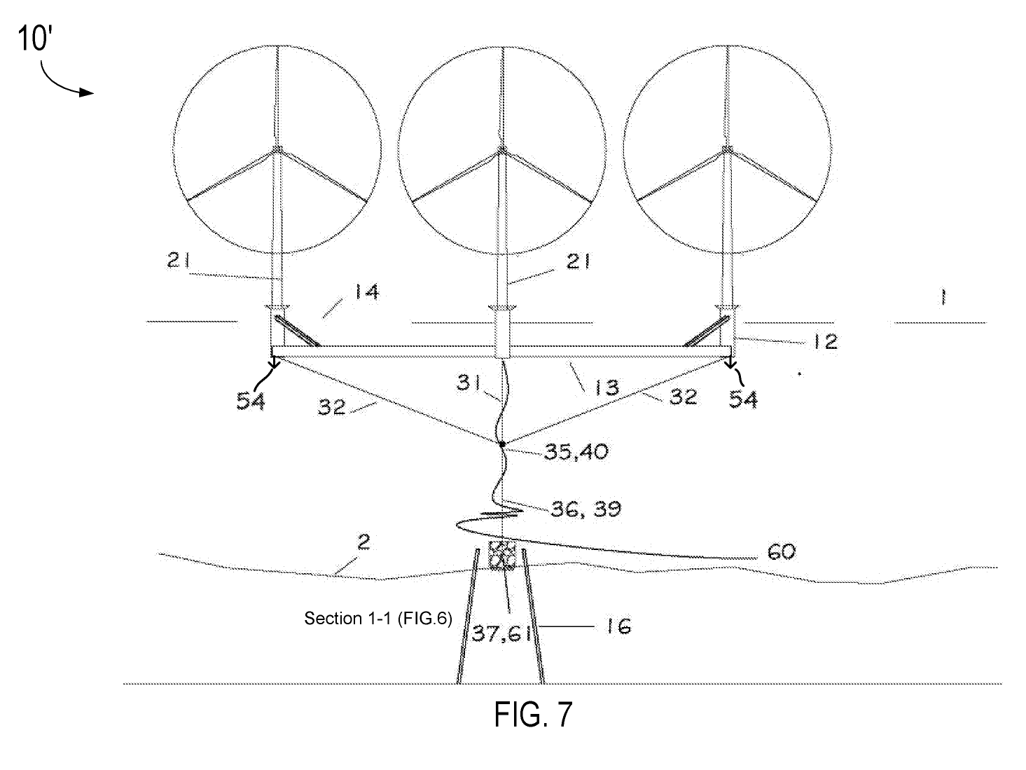

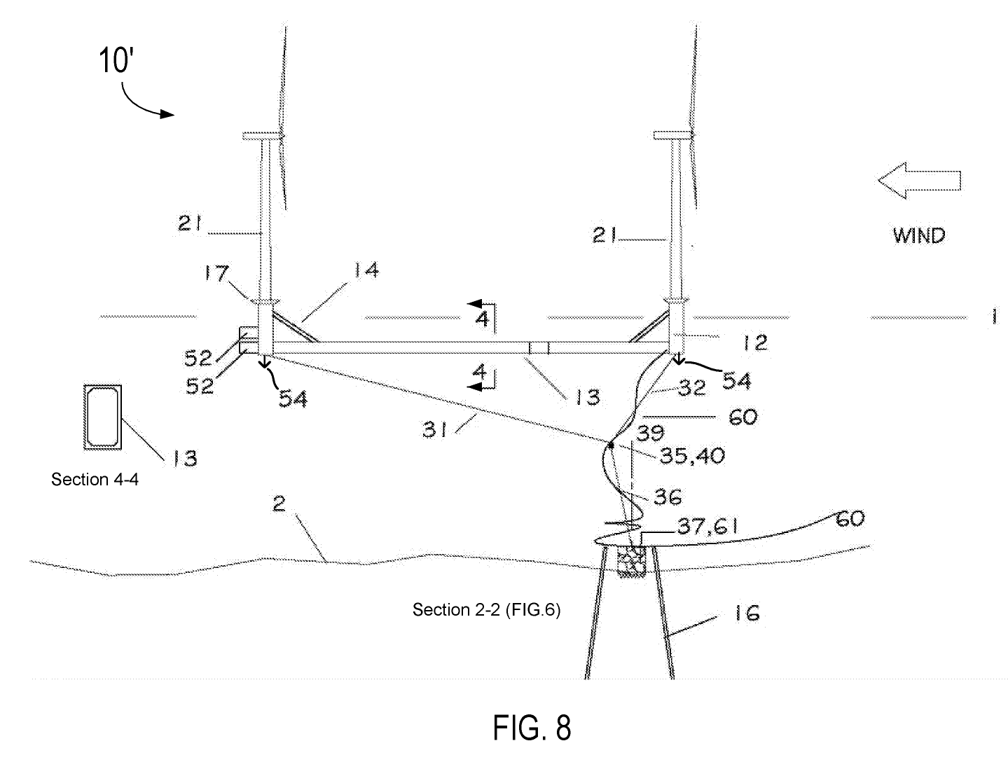

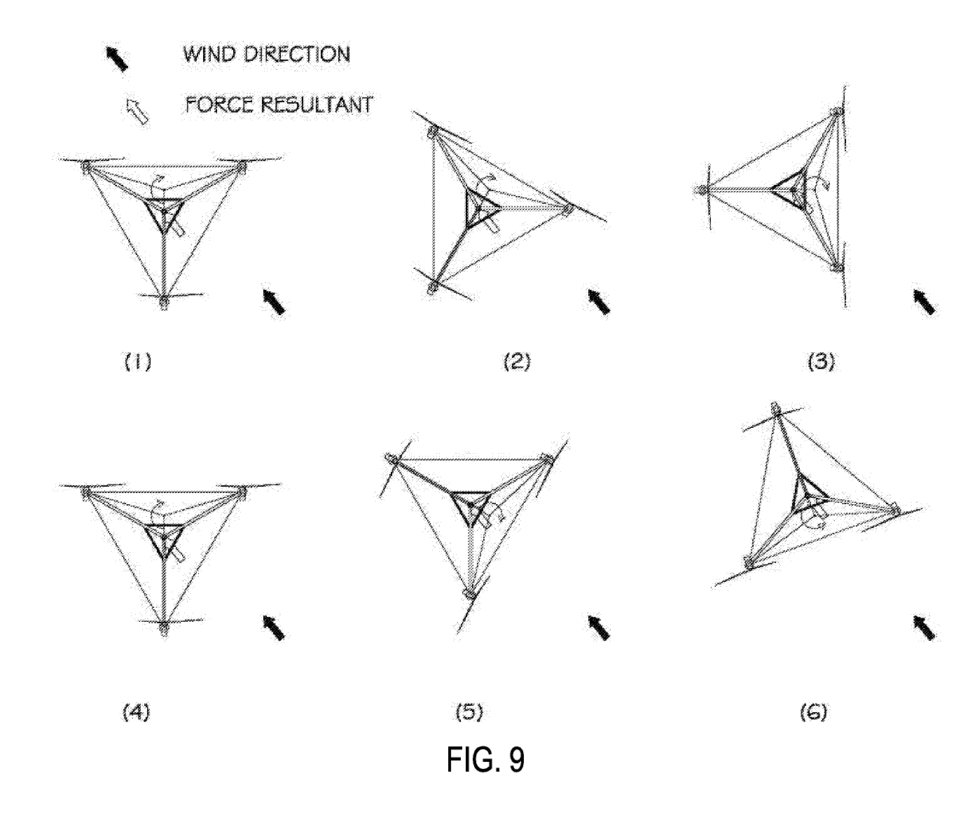

FIG. 6 is a plan view of a star-shaped semi-submerged raft wind power generation unit according to another example embodiment; FIG. 7 is a sectional view 1-1 of FIG. 6; FIG. 8 is a sectional view 2-2 of FIG. 6; and FIG. 9 is a diagram illustrating how the star-shaped semi-submerged raft wind power generation unit rotates upon a sudden change of wind direction. As this embodiment is similar in many respects to the triangular configuration shown and described in FIGS. 2-5, only the differences are discussed in detail. Referring to FIGS. 6 through 9, the star-shaped semi-submerged raft wind power generation unit 10′ configuration (hereafter raft 10′) is a variation of the triangle configuration, in which the sides of the triangle are replaced by tensioned cables 22 and the connection beams 13 become three-pointed arms 13 connected between the center of geometry 50 and the floaters 12 in the vertices of the triangle. The floaters 12 remain in the vertices. Diagonal struts 14, 15 are used to strengthen the connection between the floater 12 and the arm.

As in the case of the triangle configuration, the layouts of the front turbines 21 also cause no wake effect on the leeward turbine 21. Also as in the case of the triangle configuration, cables 31 and 32 are each connected at one end to the bottom of the floater 12 and the other end is socketed into the socket joint 35, offset from the C.G. 50 at a distance to be designed and towards the windward side. The rotor plane of two turbines 21 on the windward side is normal to the wind direction, whereas the third turbine 21 is on the leeward side symmetrically placed between the windward turbines 21, see FIG. 6 for example. A vertically connected mooring line 36 connects the socket joint 35 and seabed anchor 37 in the seabed 2. As in the case of the triangular configuration, cables 31, 32 and the mooring line 36 may be optionally introduced with a tension force forming a single tension leg foundation. The turning mechanism is similar to that used in the triangular-shaped raft 10 as described in FIGS. 2-5 and henceforth is not repeated herein. A multiple anchor system may also be used in a storm or typhoon period to stabilize the raft 10′. Although only the triangle and star configurations have been described hereinabove, the skilled artisan understands that possible configurations for the raft are not limited to those described in the specification, but also apply to other geometric configurations.

FIG. 9 outlines the turning mechanism of the star-shaped wind tracing rotational semi-submerged raft wind power generation unit 10′ under the change of wind direction. It is similar to FIG. 5 in principle and hence is not repeated herein. But it is noted here that in FIG. 9, internal diagram (6) shows that the raft 10′ is over turned and a restore moment is set up to return it back to the normal position.

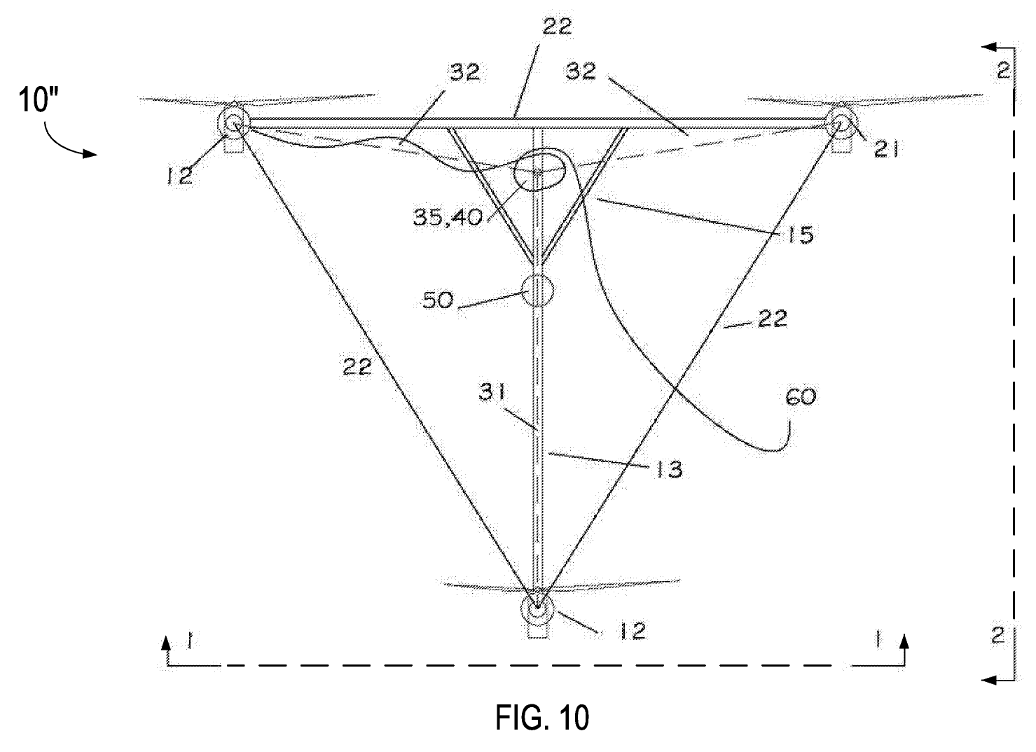

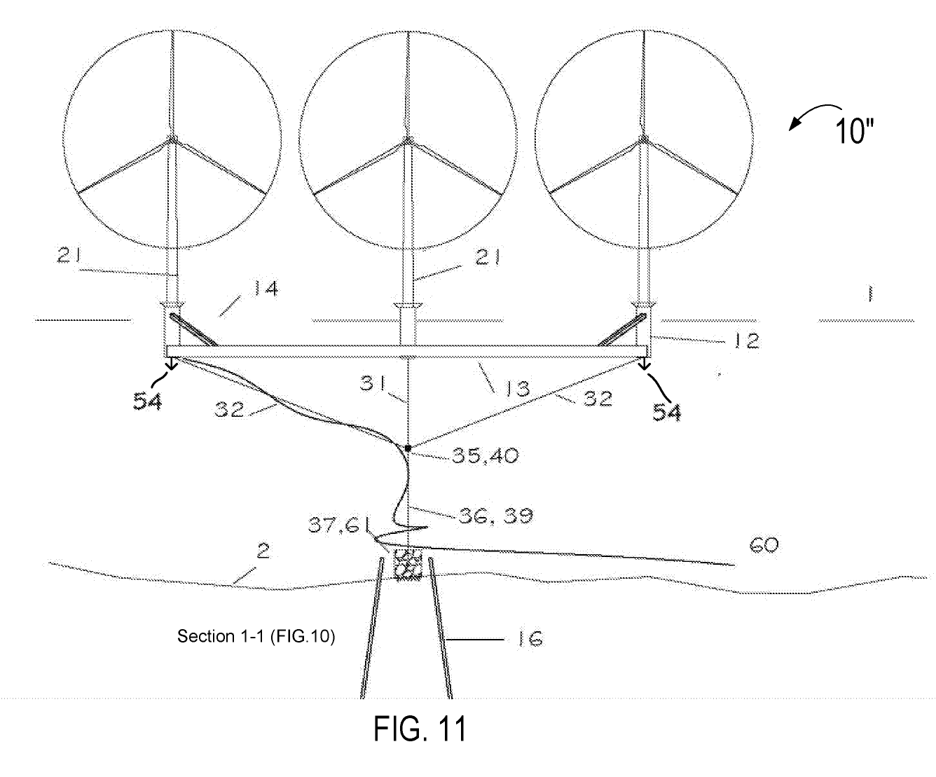

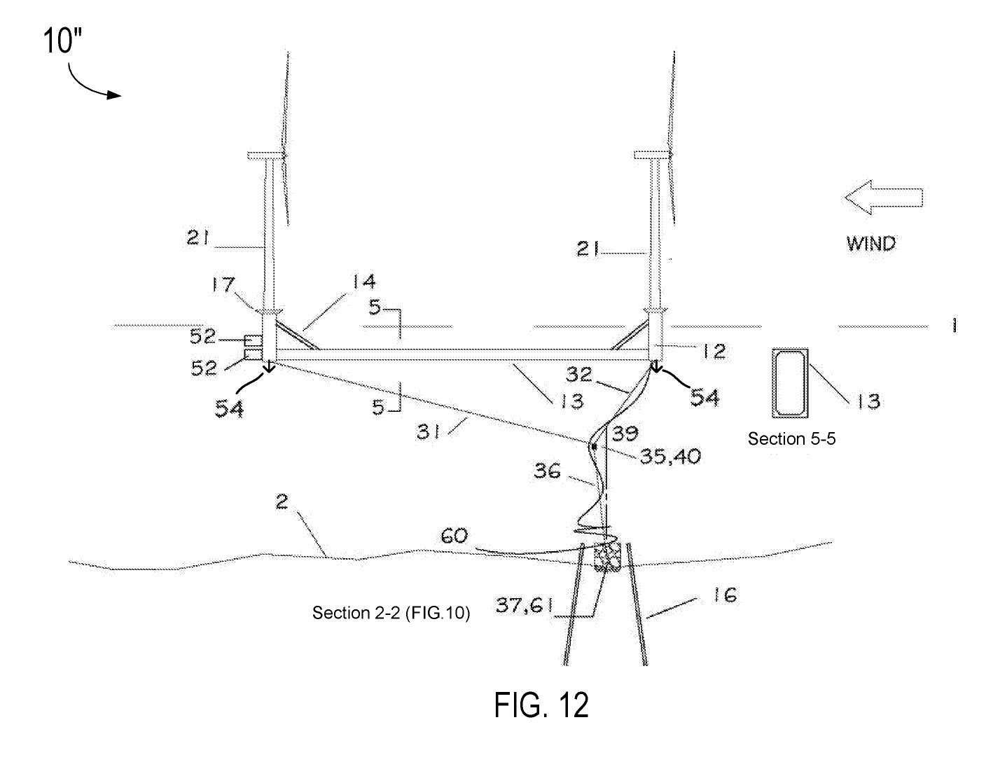

FIG. 10 is a plan view of a T-shaped semi-submerged raft wind power generation unit according to another example embodiment; FIG. 11 is a sectional view 1-1 of FIG. 10; and FIG. 12 is a sectional view 2-2 of FIG. 10. As this embodiment is similar in many respects to the previous configurations shown and described in FIGS. 2-9, only the differences are discussed in detail. Referring to FIGS. 10 through 12, there is shown a variation of the star-shaped configuration of FIGS. 6-9, in which the connection point of the arms to the midpoint of the side joining the two windward floaters is moved so as to form a “T”, hence a T-shaped semi-submerged raft wind power generation unit 10″. The arrangement of the cables 31, 32 and the single tension leg mooring line 36 is similar to the previous embodiments and hence is not repeated herein for sake of brevity.

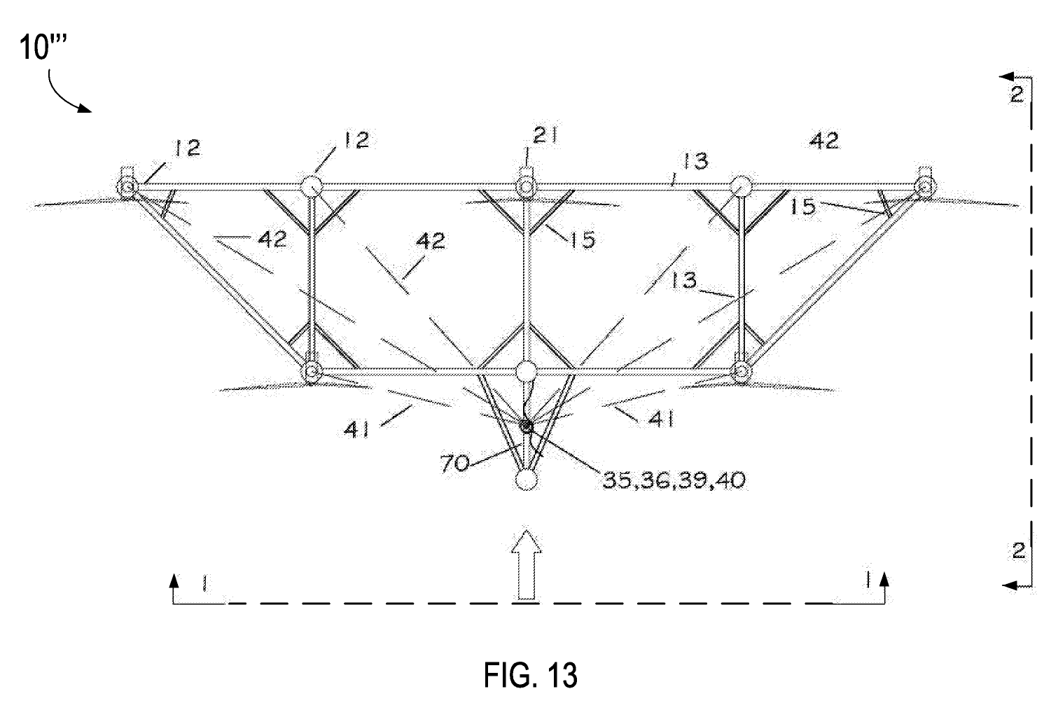

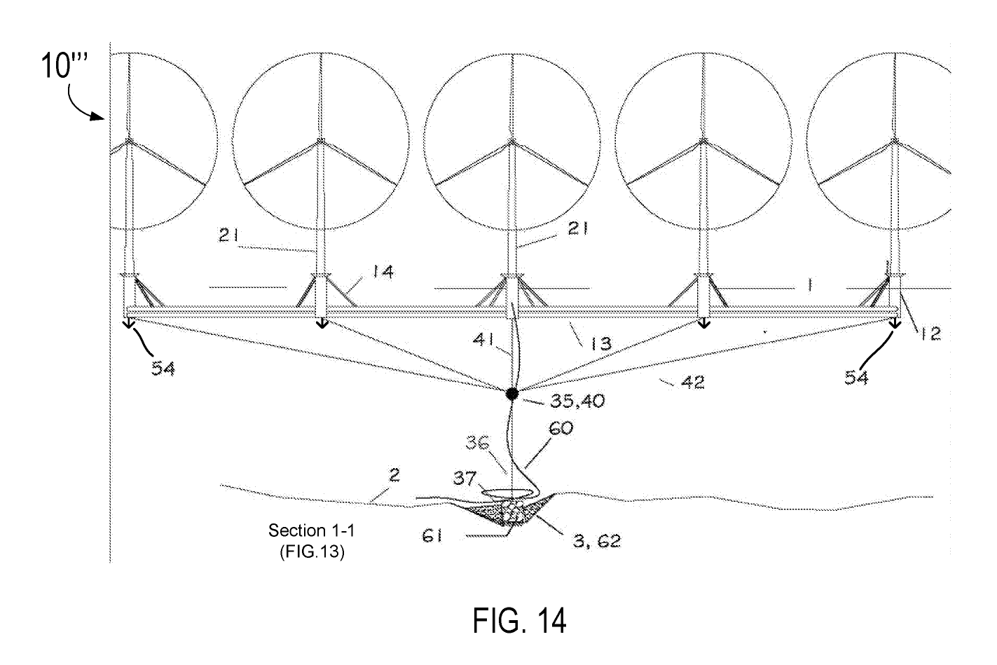

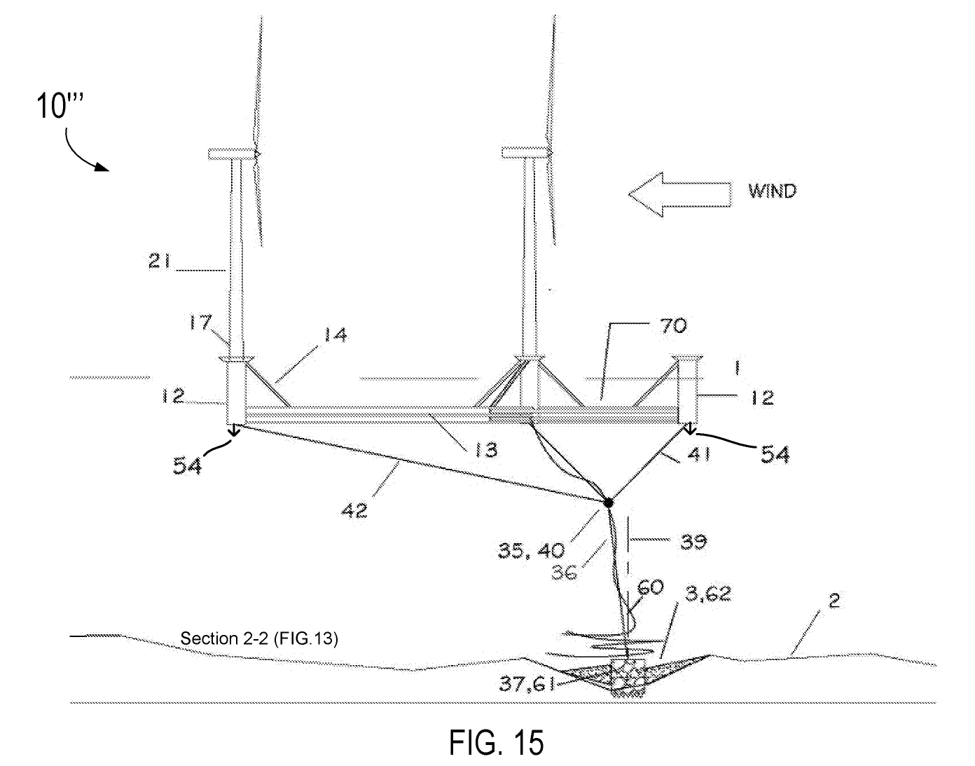

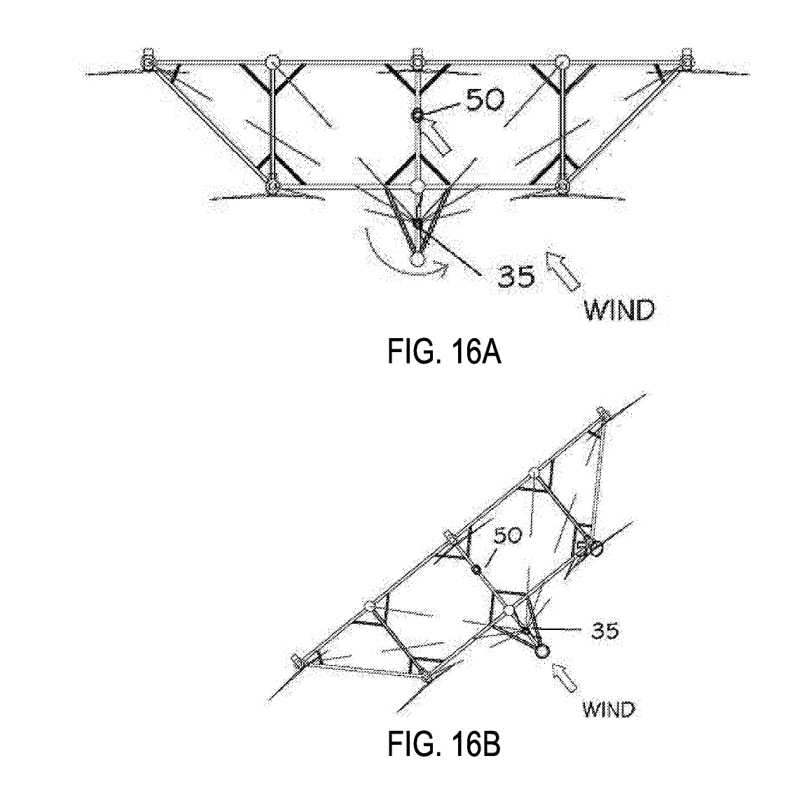

FIG. 13 is a plan view of the wind tracing rotational semi-submerged raft wind power generation unit in a trapezoidal layout; FIG. 14 is a sectional view 1-1 of FIG. 13; FIG. 15 is a sectional view 2-2 of FIG. 13; and FIGS. 16A and 16B illustrate how the semi-submerged raft wind power generation unit rotates to align in the wind direction after a sudden change of wind direction. As this embodiment is similar in many respects to the previous configurations shown and described in FIGS. 2-12, only the differences are discussed in detail. Referring to FIGS. 13 through 16B, there is shown a trapezoidal-shaped, semi-submerged raft wind power generation unit 10′″ (hereafter “raft 10′″”). Raft 10′″ includes two (2) rows of floaters 12; a windward row containing three (3) floaters 12 and a leeward row containing five (5) floaters 12. A turbine 21 rests on each alternate floater 12, i.e. two turbines 21 in the windward row and three turbines in the leeward row. The floaters 12 are interconnected by underwater connection beams 13 in a generally triangular pattern. A rigid arm 70 from the mid-floater 12 of the windward row is extended into the incoming wind and connected to a floater 12.

Cables 41 and 42 each have one end attached to the bottom of the floaters 12, with their free ends socketed into the socket joint 35 that is located in an offset position relative to the windward row, at a distance into the windward side that is approximately in the middle of the rigid arm 70. The mooring line 36 connects the socket joint 35 and the seabed gravity anchor 37, allowing turning of the raft 10′″ by twisting in the mooring line 36. As with the triangular configuration of FIGS. 2-5, a tension leg platform may be formed using a pre-sinking procedure in order to improve the stability of the platform under operating conditions. As in the other example embodiments, stability during a storm or typhoon period is provided by two methods: the employment of multiple ship's anchors 54, and the sinking to the seabed procedure (provided the water depth is within certain criteria).

FIG. 17 is an elevation view to illustrate an optional conic object 6 being added to the bottom of the floater for landing on the seabed. More specifically, FIG. 17 illustrates a raft 10 that has taken in water so as to sink to the seabed 2 under an extraordinary huge wave attack. This is done to avoid damage to the connection beam 13. The bottom of each floater 12 is equipped with a conic object 6 with its apex pointing downward (see the enlargement or DETAIL A), so that it can penetrate into the seabed 2 to increase the resistance to horizontal forces.

A prior survey of the seabed 2 should be carried out, and the area cleared if necessary for landing. After the passing of the storm, the raft 10 is raised by pumping out the water and continues with power production. In a case where multiple ship's anchors 54 are employed to stabilize the raft 10 during the storm, the ship's anchors 54 are retracted and the raft 10 is turned by the natural wind in order to face the wind.

The distance between two adjacent turbines 21 is taken as 1.8D to 2.2D, where D is the diameter of the rotor. For a 5 MW turbine where the rotor is 120 m, the distance will be in a range of about 216 m to 240 m. The distance between rows of floaters 12 is taken as 1.0D or the height of the tower, whichever is greater. The trapezoidal configuration shown in FIGS. 13-16B allows the windward turbines 21 to cast their wake shadows on the empty space in the leeward row of turbines 21, thereby eliminating the wake effects on those turbines 21. The size of the floaters 12 in the two rows may be different. The main purpose of employing floaters 12 in differing sizes is to have the center of gravity as close as possible to the center of floatation in the horizontal plane.

Referring now to FIGS. 16A and 16B, the turning mechanism of the trapezoid-shaped raft 10′″ is similar to that of triangular configuration described with respect to FIGS. 2-5. In other words, raft 10′″ will only become stationary when the force resultant of the wind load passes through the vertical turning axis 39 located at the center of socket joint 35, together with the center of geometry 50. Alternatively, raft 10′″ can be turned by aiming the turbine 21 at an angle to the incoming wind using wind force to push the raft 10′″ to turn.

In the above example, all power output cables from the individual turbines 21 of the raft 10′″ are grouped into one final power output cable 60. For the triangular, star and T-shapes rafts (10, 10′, 10″), the power output cable 60 comes out of the raft 10, 10′ and 10″ along one of the structural cables 31 or 32 and along the mooring line 36 to the seabed gravity anchor 37. In the case of the trapezoidal-shaped raft 10′″, the power output cable 60 comes out from the raft 10′″ and along one of the structural cables 41 and the mooring line 36 to the seabed gravity anchor 37. After that, the power output cable 60 runs over the seabed 2 to the shore or near shore substations.

A substantially extra long length of the power output cable 60 (in the form of loosened coils) is reserved for harmless twisting of the power output cable 60 when the raft 10′″ is turned around the vertical rotational axis 39. The raft 10′″ can also be designed with an active turning capability. The on-board computer of the raft 10′″ may record the circular angle that the raft 10′″ has turned, and, if the turn is close to the permissible limit and if the wind is predicted to change its direction to force the raft 10′″ to turn to the permissible limit, the action will be to check with the metrological data if the changing of wind direction lasts for certain period, e.g. days, and the computer will order the raft 10′″ to conduct an active turn.

The active turn will orientate one of the turbines 21 to catch the wind force and produce a yaw moment to turn the raft 10′″ back 360° so that the twisting of the power output cable 60 is released in preparation of the coming change of wind direction. During the storm period, a ship's anchor 54 that is installed in each floater 12 will be dropped into the seabed 2 so as to realize a multiple anchor system to prevent raft 10′″ from turning in the storm. In this respect, the power output cable 60 is protected from a damaging twisting action. Furthermore, the ship's anchor 54 is held by two working ropes 53, one being stronger and longer to serve a reserve role in case the other working rope 53 fails.

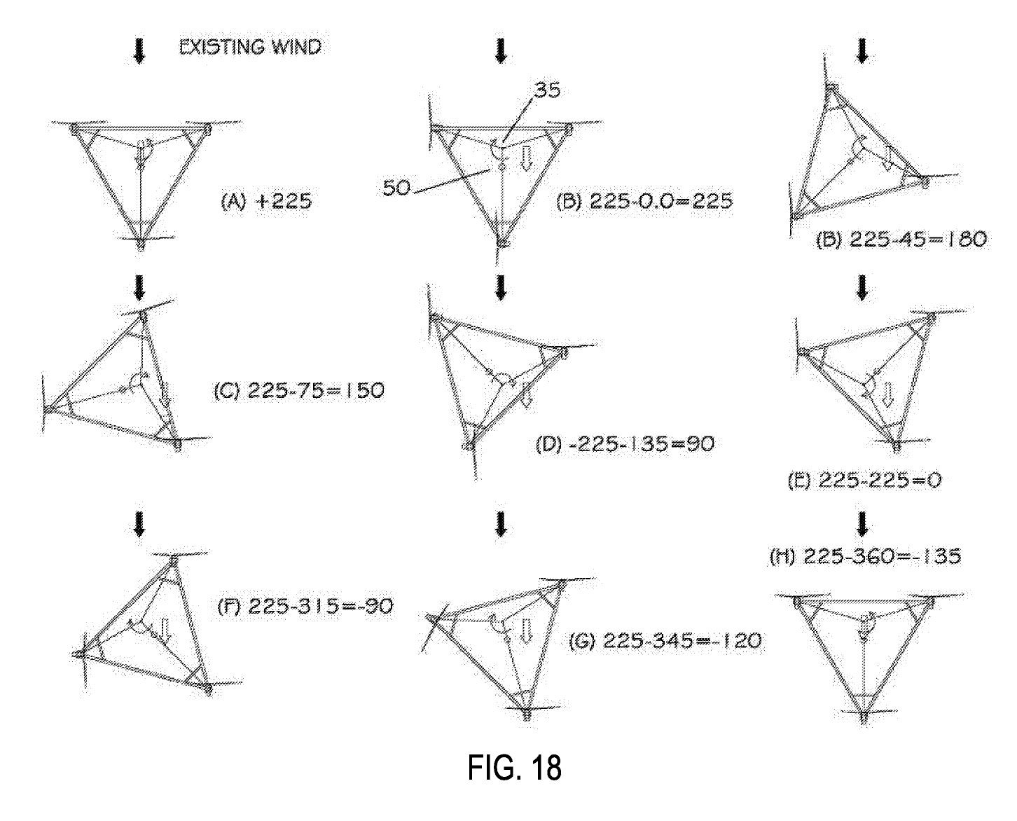

FIG. 18 is a diagram illustrating how the triangular semi-submerged raft wind power generation unit rotates 360° to loosen a twisted power cable. More specifically, internal diagrams (A) through (H) of FIG. 18 are provided to help explain, based on the triangle configuration, how to turn raft 10 back 360° in an active turn. Initially, if the existing wind direction is north, and the power cable 60 has been twisted counter-clockwise 225°, refer to internal diagram (A). Based on the metrological forecast, the wind will change to northwest. In such a situation, if no adjustment is made to the twisting of the power output cable 60, the raft 10 will continue to turn counter-clockwise to follow the wind; this will cause the power output cable 60 to twist to the limit, e.g., 360°. Therefore, an immediate clockwise turn of the raft 10 is necessary. Accordingly, internal diagrams (B)-(H) of FIG. 18 illustrate the procedures to orient the turbine 21 into the northern wind and in a controllable manner to bring the raft 10 turning back 360°, in preparation for the predicted twisting due to the northwestern wind.

As to the number of wind turbines 21 in the aforementioned example embodiments, the wind tracing rotational semi-submerged raft wind power generation unit theoretically has no restrictions. The only potential limitation is how large a floating structure that the technology can handle safely in the open sea.

The exemplary raft 10 structure may be composed of pre-stressed concrete hollow connection beams 13 and floaters 12; otherwise if using steel, heavy ballast is used in order to reach the semi-submerged state. The construction method is similar to that of a bridge using a segmental construction method. In general, a harbor with adequate water depth to receive the semi-submerged raft 10 is selected. Using the aforementioned assembly method, the raft 10 is assembled in the harbor with the help of temporary guiding piles 48. The completed raft 10 typically will have the turbines 21 installed before it is towed to the site.

At the wind farm site, a number of the rafts 10 are installed as shown in FIG. 1(B). The power production efficiency is improved by the full time wind facing turbines, also the power output cable 60 is shortened, giving an efficient power transmission.

The seabed gravity anchor 37 is designed to ensure that it is not displaced substantially during the storm period. One of the possible methods as shown in FIGS. 3 and 4 is to excavate a deep ditch 3 in the seabed 2, and lower the seabed gravity anchor 37 into the ditch 3. If the seabed gravity anchor 37 tries to leave the ditch 3, it has to move upward, a movement that requires great energy. The weight of the seabed gravity anchor 37 therefore should be greater than the uplifting force by the storm, greater by an allowable margin. Another method is as shown in FIGS. 7 and 8 wherein, at the anchorage location, raking piles 16 are driven into the seabed 2 to form a ring around the location, with the piles 16 protruding out of the seabed 2. The seabed gravity anchor 37 is then lowered into the anchorage location surrounded by the protruding piles 16. Similarly, the weight of the seabed gravity anchor 37 therefore should be greater than the uplifting force by the storm by an allowable margin. In the case of using a piled foundation, the design is to ensure that the pile-allowable tension capacity will not be exceeded by the action of the storm.

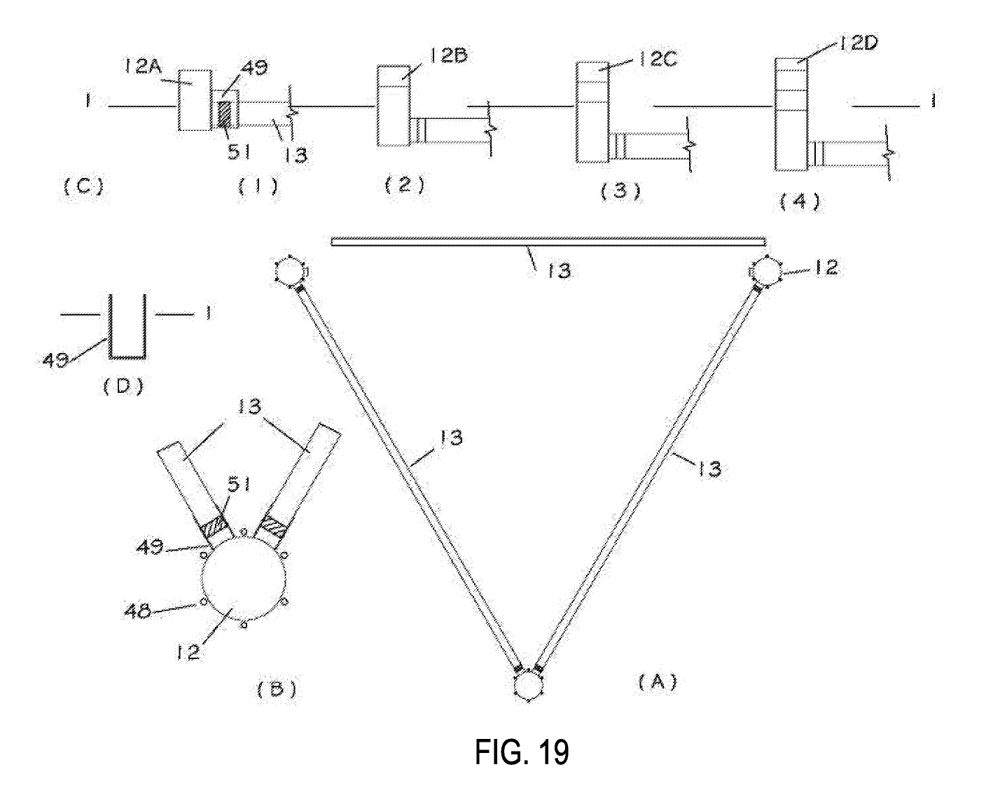

FIG. 19 is a diagram illustrating fabrication steps (A) through (D) in the assembly and construction of the wind tracing, rotational, semi-submerged raft wind power generation unit in accordance with the example embodiments.

Of note, the following method of fabrication is not limited to performing the steps in any specific order; the skilled artisan in the industry may derive any suitable organization of steps using known technologies. The example method of fabrication as described in FIG. 19 may include one or more of the following steps:

1. match casting of segments for the floaters 12 and the connection beams 13 in the factory or casting yard;

2. selecting a quiet harbor to assemble the connection beams 13 into several sections, i.e., 50 m sections, on land using traditional bridge construction methods;

3. sealing the two ends of each section of the connection beams 13, transporting the beam sections to sea, and using known technologies to assemble the sections into the connection beams 13. A short length (e.g., about 1.5-2.0 m) of each connection beam 13 at its two ends joining the floaters 12 is left uncast with reinforcement protruding out for future connection to the floaters 12;

4. driving at least three guiding piles 48 into the seabed 2 at the location where the floaters 12 are to be deployed. The piles 48 should extend above the sea level 1 a certain distance and the upper parts of the guiding piles 48 can then be dismantled;

5. as shown in FIG. 19, substep (C)(1), floating in a first floater segment 12A, lowering the first floater segment 12A into the space bounded by the guiding piles 48, and fixing floater segment 12A to the piles 48 after checking the level and verticality of the first floater segment 12A;

6. next, floating in the connection beam 13, aiming it at the first floater segment 12A, and temporarily fixing it to the piles 48. The connection beam 13 should be made shorter, e.g., 2 m shorter on each end for insitu concrete casting;

7. erecting the formwork 49, the top of which should be above water, between the first floater segment 12A and the connection beam 13, and sealing a gap therebetween to make the formwork 49 water tight;

8. pumping out the water in the formwork 49 and fixing steel reinforcement between the first floater segment 12A and the connection beam 13, cast concrete 51 and install pre-stressing (if needed);

9. when all first floater segments 12A are connected by connection beams 13, free the first floater segments 12A and connection beams 13 from the guiding piles 48; the remaining or subsequent floater segments 12B, 12C, 12D are added and fixed on top of each one to complete the floater construction, see substeps (C)(2) to (C)(4) of FIG. 19;

10. installing turbines 21 after the completion of the raft 10 and at the same time, installing the cable lines 31, 32 at each completed floater 12;

11. freeing the raft 10 from the guiding piles 48, and floating out the raft 10 for transportation to the site for installation;

12. at the site of installation, preparing the foundation. The foundation could be a piled foundation, but a caisson foundation is more convenient and this requires the excavation of a large ditch in the seabed 2 to accommodate the caisson. Alternatively, employing a caisson inside a ring of raking piles 16 is another option;

13. measuring, on site, the actual length of the mooring line 36 needed in conjunction with the pre-sunk depth (if any) and the caisson size. Attaching the anchor mooring line 36 to the caisson (empty), and sinking the raft 10 by taking in water until the caisson is sitting on the leveled seabed 2 of the ditch 3;

14. filling the caisson with stones or concrete 61 and the ditch 3 with sand and gravel 62 to complete the installation. Pump out water (if needed) in the raft 10 to introduce tension in the anchor mooring line 36 as in the case of a single tension leg structure; and

15. connecting the power output cable 60 so as to begin generating electricity.

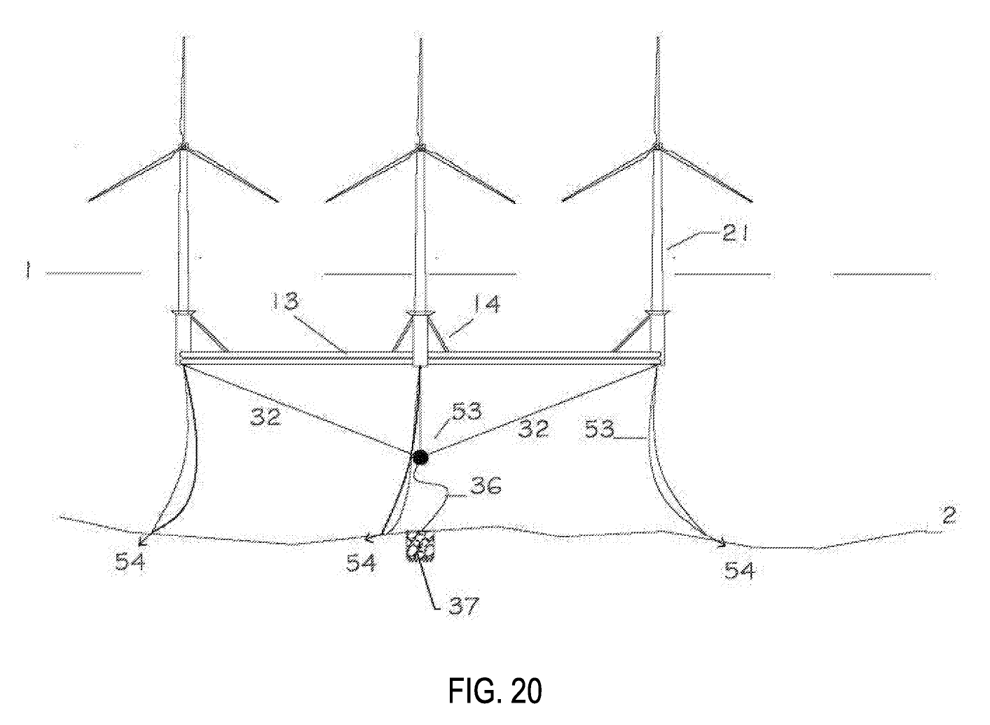

FIG. 20 is an elevation view to illustrate how the semi-submerged raft wind power generation unit sinks into the water and drops ship's anchor onto the seabed in order to stabilize the raft against a storm attack.

Therefore, in the example wind tracing rotational semi-submerged raft wind power generation units heretofore described, because of the semi-submerged raft 10, several wind turbines 21 may be grouped to form an integral floating wind power generation unit. Since the raft 10 can be turned into the wind full time, spacing between wind turbines 21 can be reduced, hence the construction of the raft 10 using pre-stressed concrete is feasible.

Using a concrete raft 10 as an example, the estimated installed rate is at par of the upper limit of land-based wind farms. Conventional fixed bottom, near shore, wind farms costs 1.5-2.0 times those of land-based ones to install complete. There is no example for the deep sea wind farm, but it should cost much more than it's near shore counterparts. From this, it is obvious that huge economic benefits may be attainable by employment of the example embodiments. The far shore option is open and can be deployed with a large number of floating wind farms.

The example embodiments are particularly suitable to the energy requirement of future ocean cities. The far shore wind speed is steady and strong and the number of utilization hours is high, thus power generation is also high and steady. The pre-stressed concrete structure can last more than 100 years, much more than the floating steel platform which has a design life of 25˜30 years. If using whole life costing as a bench mark, the same concrete structure can support four generations of wind turbines. The spread construction cost is even less. Accordingly, the example embodiments can aid realization of a far shore wind farm at a much fast pace. The zero emissions, the low cost, high efficiency, and environmental friendliness are some of the highlights of the example embodiments of the present invention.

The example embodiments being thus described, it will be obvious that the same may be varied in many ways. Such variations are not to be regarded as departure from the example embodiments, and all such modifications as would be obvious to one skilled in the art are intended to be included within the following claims.

1. A semi-submergible raft wind power generation unit, comprising:
at least three floaters,
at least three wind turbines configured for placement on the floaters, wherein
the raft wind power generation unit is adapted to turn about a vertical rotational axis and be fixed to a seabed by a mooring line, and
a force resultant from a wind load on the raft wind power generation unit passes closely around the center of geometry thereof, which is a distance away from the center of rotation thereof so that a yaw moment about the center of rotation is created that rotates the raft wind power generation unit until the force resultant passes through the center of geometry and center of rotation.

2. The raft wind power generation unit of claim 1, wherein rotors of the wind turbines are in a perpendicular direction to the incoming wind when the force resultant from the wind load passes the center of rotation and center of geometry.

3. The raft wind power generation unit of claim 1, wherein the center of rotation is in front of the center of geometry as the raft wind power generation unit faces into the incoming wind.

4. The raft wind power generation unit of claim 1, wherein the at least three floaters are configured in a triangular shape of an equilateral triangle, the at least three floaters located at vertices of the triangle with turbines on two of the three floaters facing into wind and being at a windward side in an operational state.

5. The raft wind power generation unit of claim 1,
wherein the at least three floaters are located at vertices of the triangle and are connected by a plurality of beams that meet at the center of geometry of the triangle, with turbines on two of the three floaters facing into the wind being at a windward side in an operational state, and
the raft wind power generation unit further comprises a stabilizing cable connecting the floaters to enhance the strength of the raft.

6. The raft wind power generation unit of claim 1, wherein
the at least three floaters are located at vertices of a triangle and are connected by a plurality of beams in a T framework,
one beam connects two floaters that are at a windward side and the other beam connects the third floater in a leeward vertex to the midpoint of the first beam, the windward turbines of the two floaters facing into the wind in an operational state, and
the raft wind power generation unit further comprises a stabilizing cable connecting the windward and leeward floaters to enhance the strength of the raft.

7. The raft wind power generation unit of claim 1, wherein
the raft wind power generation unit includes nine floaters in a shape of a trapezoid in two rows,
a windward row includes three floaters whereas a leeward row includes five floaters with a plurality of beams connecting each floater in a triangle pattern, and
a wind turbine is located at alternate floaters so that there are two turbines in the windward side and three in the leeward side, and
the raft wind power generation unit further comprises a rigid arm extended from the middle floater of the windward row into the incoming wind and connected at its tip to a floater.

8. The raft wind power generation unit of claim 1, further comprising three cable lines, each of which connects to a bottom of the floater and meets at a socket joint that provides sockets for fixing the cables thereto, the cables connected by a mooring line to a seabed anchor so that the raft wind power generation unit is able to rotate about its center of rotation.

9. The raft wind power generation unit of claim 1, further comprising a rudder located at the leeward floater of the triangular layout and at the leeward middle floater of the trapezoidal layout to counter balance ocean currents in the water so as to eliminate current effects on the yaw movement of the raft wind power generation unit.

10. The raft wind power generation unit of claim 8, wherein a connection point is provided for the cables and mooring line so that rotation of the raft wind power generation unit is effected by twisting the mooring line connected between the raft wind power generation unit and the seabed anchor.

11. The raft wind power generation unit of claim 8, wherein a power cable from each of the grouped turbines is coupled to a final power output cable attached to and running down along a corresponding cable line and the mooring line to the seabed, the final power output cable arranged in a form of loosened coils that absorb a degree of twisting about the vertical axis along the mooring line.

12. The raft wind power generation unit of claim 1, further comprising a ship's anchor provided at each floater.

13. The raft wind power generation unit of claim 1, wherein each floater bottom includes an optional downward pointing conic object.

14. The raft wind power generation unit of claim 1, wherein outermost turbines on the raft wind power generation unit are equipped with a yaw rotating mechanism enabling the turbines to turn under instruction, wherein other turbines on the raft wind power generation unit are configured in a fixed direction and aligned to the axis joining the center of geometry and the rotation center, without a yaw rotating mechanism.

15. The raft wind power generation unit of claim 1, wherein a wake shadow created by the front windward turbines will not cast on the leeward turbines.

16. The raft wind power generation unit of claim 1, wherein the raft wind power generation unit is adapted to be pulled down into water by the mooring line to a designed depth.

17. The raft wind power generation unit of claim 8, wherein the seabed anchor is configured as a gravity-type anchor in the seabed.

18. A wind farm adapted to generate electricity by the action of wind in the open sea, comprising a plurality of semi-submergible raft wind power generation units as recited in claim 1.

19. A construction method for fabrication of a semi-submergible raft wind power generation unit, the method comprising:
match casting a plurality of beam segments that make up at least three floaters and their associated connection beams,
sealing ends of the beam segments and transporting the connection beam and floater segments to an assembly site at a harbor by land or by sea,
sinking at least three piles per floater at a location where a floater is to be positioned at the assembly site, the at least three piles serving as guiding piles to confine the location of the floater,
temporarily fixing a first bottom floater segment inside a space bounded by the guiding piles,
assembling the floater and connection beam segments either on land or in the water,
bringing assembled beams to a joint position of the floaters temporarily fixing the assembled beams to the guiding piles,
setting up a steel mold and sealing a gap between the steel mold and the floater and beam surfaces,
pumping water out of the steel mold,
fixing reinforcement in the joint at the floaters,
casting concrete in the mold and curing the wet concrete, wherein, once the concrete has reached its design strength, freeing the floater and connection beams that have been temporarily fixed at the guiding piles,
loading a next floater segment onto the first bottom segment and connecting them with an epoxy coated joint together with pre-stressed steel bars,
repeating the loading and connecting steps until the last floater segment has been connected,
installing a wind turbine on the floater,
attaching a cable to the bottom end of each floater and bringing free ends of the cables to a meeting point, wherein the meeting point is at the center of a socket joint for the connection of the cables and a mooring line to the floater bottom and a seabed anchor, and
the location of the meeting point does not coincide with the center of gravity of the formed raft wind power generation unit but is offset from the center of gravity at a distance into the windward side of the raft wind power generation unit.

20. The method of claim 19, further comprising:
excavating a ditch in the seabed to accommodate a caisson,
measuring, on site, the actual length of the raft wind power generation unit in conjunction with the pre-sunk depth needed for the mooring line,
attaching the mooring line to the caisson,
sinking the raft wind power generation unit by taking in water until the caisson is sitting on the leveled seabed of the ditch,
filling the caisson with stones or concrete and the ditch with sand and gravel to complete the installation, and
pumping water out of the raft wind power generation unit to introduce tension in the mooring line as in the case of a single tension leg structure.

21. The method of claim 19, further comprising driving a plurality of raking piles into the seabed in a ring layout surrounding the seabed anchor, the raking piles protruding above the anchor.
